(19) United States
(12) Patent Application Publication
(10) Pub. No.: US 2010/0129701 A1
(43) Pub. Date: May 27, 2010

(54) Battery packs

(75) Inventors: Tsuyoshi Murayama, Anjo-shi (JP); Kiyozumi Kokawa, Anjo-shi (JP); Kazutoshi Ogino, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, ANJO-SHI (JP)

(21) Appl. No.: 12/591,497

(22) Filed: Nov. 20, 2009

(30) Foreign Application Priority Data
Nov. 25, 2008 (JP) 2008-299319

(51) Int. Cl. H01M 2/10

(52) U.S. Cl. 429/97

(57) ABSTRACT

One aspect according to the present invention includes a battery pack having a battery pack body. The battery pack body includes a finger engaging portion engageable with a finger or fingers of an operator in a removing direction of the battery pack body from a power tool.

This application claims priority to Japanese patent application serial number 2008-299319, the contents of which are incorporated herein by reference.

### BACKGROUND OF THE INVENTION

1. Field of the Invention

The present invention relates to battery packs that are used, for example, as power sources of portable power tools.

2. Description of the Related Art

In general, a battery pack of a power tool can be removed from a tool body and recharged in order to repeatedly use the battery pack. For example, in known portable power screwdrivers, such as those disclosed in EP1128517A2 and Japanese Laid-Open Patent Publication No. 2001-238362, a battery pack is slidably mounted to and removed from a battery mounting portion provided at a leading end of a handle portion that extends laterally from a tool body. When the battery pack is slidably moved by an operator so as to be mounted to the battery mounting portion, the battery pack is electrically connected to a power source circuit of the tool body. On the other hand, when the battery pack is slidably moved in a removing direction, the battery pack is removed from the battery mounting portion and is electrically disconnected from the power source circuit. The removed battery can be slidably mounted to a mounting portion of a battery charger that can recharge the battery.

In the case that the battery pack is small and lightweight, the battery pack can be easily handled and the mounting and removing operations of the battery pack can be made without difficulties. However, in recent years, battery packs having large outputs (such as 36V) have been used Because, these battery packs are large in size and heavy, the handling of the battery packs cannot be easily made.

Therefore, there is a need in the art for enabling a battery pack to be easily removed from a tool body of a power tool.

### SUMMARY OF THE INVENTION

One aspect according to the present invention includes a battery pack having a battery pack body. The battery pack body includes a finger engaging portion engageable with a finger or fingers of an operator in a removing direction of the battery pack body from a power tool.

### BRIEF DESCRIPTION OF THE DRAWINGS

FIG. 1 is a perspective view of a power tool and a battery pack according to an embodiment of the present invention and showing a mounted state of the battery pack to the power tool;

FIG. 2 is a perspective view of the battery pack;

FIG. 3 is a plan view of the battery pack as viewed in a direction indicated by an arrow (III) in FIG. 2;

FIG. 4 is a perspective view of the battery pack as viewed in a direction indicated by an arrow (N) in FIG. 2;

FIG. 5 is a perspective view of the battery pack and showing the state where a lock button is pressed down by an index finger of an operator; and

FIG. 6 is a perspective view of the battery pack and showing the state where the lock button is pressed downwardly by a thumb of an operator.

### DETAILED DESCRIPTION OF THE INVENTION

Each of the additional features and teachings disclosed above and below may be utilized separately or in conjunction with other features and teachings to provide improved battery packs and power tools incorporating the battery packs. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

In one embodiment, a battery pack for a power tool includes a battery pack body capable of being removed from the power tool in a removing direction. The battery pack body includes a finger engaging portion engageable with a finger or fingers of an operator in the removing direction of the battery pack body.

With this arrangement, the finger engaging portion can serve as a slip preventing portion when the operator engages the finger engaging portion with his or her finger(s) for removing the battery pack from the power tool. Therefore, the battery pack can be easily removed from the power tool even in the case that the battery pack has a large size and a heavy weight. Hence, handling of the battery pack can be facilitated.

The battery pack may further include a lock device and an operation member. The lock device is capable of releasably locking the battery pack body against the power tool. The operation member is operable for unlocking the lock device. The battery pack body may further include left and right and second side portions disposed on opposite sides with respect to the operation member and a bottom side portion extending substantially perpendicular to the left and right side portions. At least one of the left, right and bottom side portions includes the finger engaging portion.

For example, in the case that the operator operates the operation member with his or her thumb, the finger engaging portion may be provided on the bottom side portion for engagement by the other finger(s) other than the thumb. In the case that the operator operates the operation member with his or her index finger, the finger engaging portion may be provided on each of the left and right side portions for engagement by the other finger(s) than the index finger. The finger engaging portion may be provided in each of the bottom side portion and the left and right side portions, so that the operator can operate the operation member with either the thumb or the index finger.

The finger engaging portion may include a linear projection disposed on the battery pack body and extending in a direction intersecting with the removing direction. Alternatively, the finger engaging portion may include a linear recess formed in the battery pack body and extending in a direction intersecting with the removing direction. Because the projection or the recess may have a long length in a direction intersecting with the removing direction, it is possible to ensure a large engageable range of the finger engaging portion for engagement with the finger(s). Therefore, handling of the battery pack can be further facilitated.

The battery pack body may further include a front side portion extending substantially perpendicular to the left, right and bottom side portions. Left and right corner portions may be defined between the front side portion and the left and right side portions, respectively. The finger engaging portion may include a left finger engaging portion disposed on the left side portion and a right finger engaging portion disposed on the right side portion. The left finger engaging portion extends along the left corner portion. The right finger engaging portion extends along the right corner portion.

With this arrangement, in the case that the operator operates the operation member that may be a lock button, the operator can position his or her index finger at the operation member and easily extend the other fingers than the index finger to the left and right engaging portions for engaging them in order to pinch the battery pack body from left and right sides. Therefore, handling of the battery pack can be further facilitated.

In the case that the finger engaging portion includes the bottom finger engaging portion disposed on the bottom side portion, the battery pack body may further include a protrusion disposed on the bottom side portion and capable of compensating inclination of the battery pack relative to a surface on which the battery pack is placed.

With this arrangement, when the battery pack is placed on a surface, such as a surface of a workbench on which the battery pack is placed, it is possible to position the battery pack such that the battery pack is oriented horizontally parallel to the surface without being inclined relative thereto. In addition, the power tool having the battery pack mounted thereto can be positioned in stable on the surface by positioning the power tool such that the bottom of the battery pack contacts the surface.

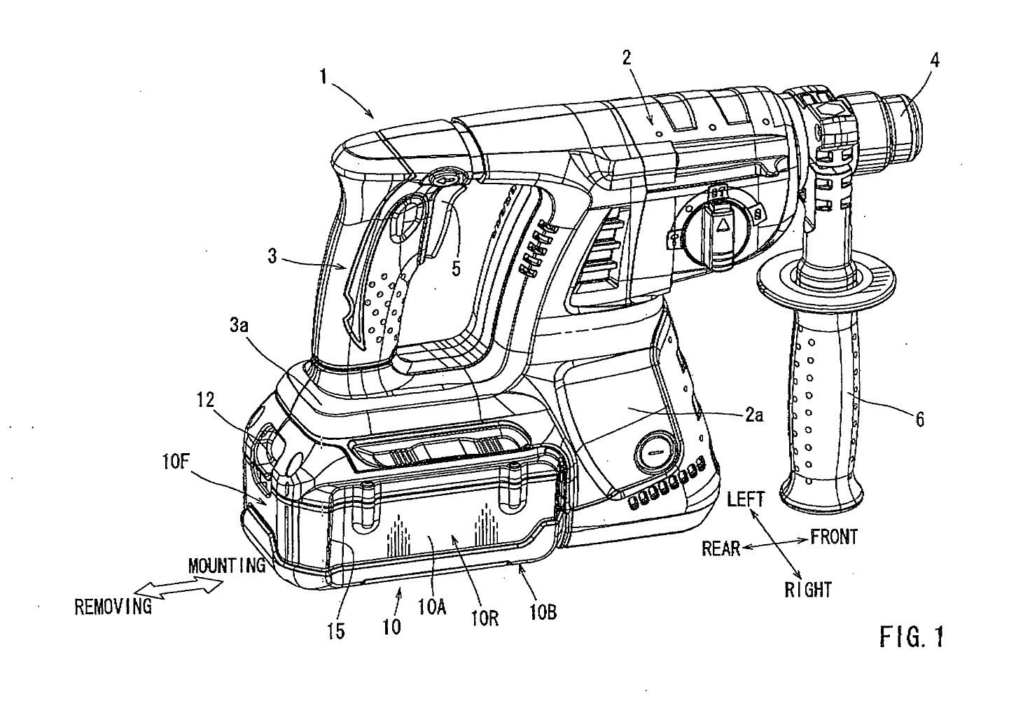

An embodiment of the present invention will now be described with reference to the drawings. Referring to FIG. 1, a power tool 1 incorporating a battery pack 10 according to the embodiment is shown. In this embodiment, the power tool 1 is configured as a hammer drill that can be used for boring, chipping and crushing of a concrete structure. The power tool 1 has a tool body 2 and a handle 3. Within the tool body 2, an electric motor (not shown) is disposed to extend vertically, so that its rotational axis extends vertically. The rotation of the electric motor is reduced by a reduction gear mechanism (not shown) and is thereafter transmitted from an output shaft of the reduction gear mechanism to a spindle 4. The output shaft of the reduction gear mechanism extends in a direction perpendicular to the rotational axis of the motor.

The handle 3 has a substantially loop-shaped configuration and is formed integrally with a rear portion of the tool body 2. A switch lever or a trigger 5 is disposed on an inner circumference of the handle 3 and can be operated by a finger or fingers of the operator in order to start the motor. An auxiliary handle 6 extends downward from a front portion of the tool body 2. Therefore, the operator can firmly hold the power tool 1, for example, by grasping the handle 3 with his or her right hand and grasping the auxiliary handle 6 with his or her left hand.

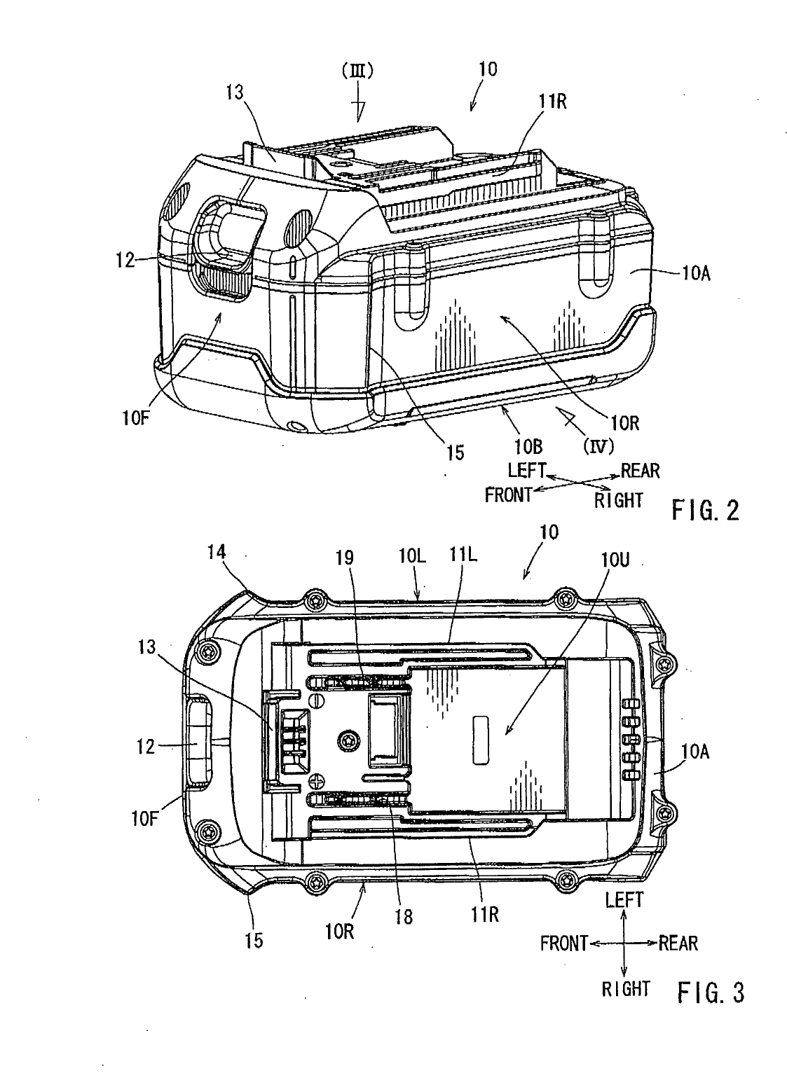

The battery pack 10 is mounted to a lower portion of the handle 3. The battery pack 10 may be a lithium ion battery having a rating voltage of 36V and can be repeatedly used by being recharged. The motor receives a supply of power from the battery pack 10. More specifically, the battery pack 10 has a battery pack body 10A and can be mounted to a battery mounting portion 3a of the handle 3 by sliding the battery pack body 10A forwardly relative to the battery mounting portion 3a. The battery pack 10 can be removed from the battery mounting portion 3a by sliding the battery pack body 10A rearwardly relative to the battery mounting portion 3a. The battery pack 10 in the state of being removed from the battery mounting portion 3a is shown in FIGS. 2 to 6.

The battery pack body 10A has a substantially hexahedron block-like configuration. A plurality of battery cells (not shown) are disposed within the battery pack body 10A. Left and right guide rails 11L and 11R are provided on a surface of an upper portion 10U of the battery pack body 10A and can engage left and right guide recesses (not shown) formed in the battery mounting portion 3a, respectively. The left and right guide rails 11L and 11R may be formed integrally with the surface of the upper portion 10U. The left and right guide recesses extend in forward and rearward directions. Therefore, the battery pack body 10A can slide in forward and rearward directions relative to the battery mounting portion 3a. When the battery pack body 10A is slid rearward, the battery pack 10 can be mounted to the battery mounting portion 3a. A positive connecting terminal 18 and a negative connecting terminal 19 are mounted to the upper portion 10U and are positioned between the left and right guide rails 11L and 11R. When the battery pack 10 is mounted to the battery mounting portion 3a of the power tool 1, the connecting terminals 18 and 19 are electrically connected to a power source circuit (not shown) of the tool body 2.

An operation member 12 is movably supported within a front side portion 10F of the battery pack body 10A and can be pressed downward by a finger or fingers of the operator for removing the battery pack 10. In this embodiment, the operation member 12 is configured as a lock button. The operation member 12 is positioned at an upper part of the front side portion 10F, and more specifically, at a central portion with respect to right and left directions of the upper part. A lock member 13 is coupled to the operation member 12 and extends vertically through the upper portion 10U. When the operation member 12 is pressed downward, the lock member 13 also moves downward. In this embodiment, the lock member 13 is configured as a claw. The operation member 12 is biased upward by a spring (not shown). Therefore, when the pressing force applied by the fingertips) of the operator is released, the operation member 12 returns upward by the biasing force of the spring. Because the operation member 12 is biased upward, the lock member 13 is also biased upward toward an engaging position. The battery mounting portion 3a has an engaging portion for engaging the lock member 13. When the battery pack 10 is mounted to the battery mounting portion 3a of the handle 3, the lock member 13 can engage the engaging portion, so that the battery pack body 10A is locked not to move in forward and rearward directions.

When the operation member 12 is pressed downwardly by a finger(s), such as a thumb and an index finger, the lock member 13 moves downward together with the operation member 12 so as to be disengaged from the engaging portion. Then, the battery pack 10 can be moved in the removing direction for removing the battery pack 10 from the battery mounting portion 3a.

In order to facilitate the removing operation of the battery pack 10, the battery pack body 10A of the battery pack 10 has finger engaging portions 14, 15 and 16. As shown in FIG. 3, the finger engaging portions 14 and 15 are provided in left and right pairs and extend along corner portions of the battery pack body 10A. The corner portions are positioned on the front sides of left and right side portions 10L and 10R and are defined between the front side portion 10F and the left and right side portions 10L and 10R, respectively. The finger engaging portions 14 and 15 project laterally outward from the corner portions. More specifically, each of the finger engaging portions 14 and 15 is configured as a linear projection extending in a vertical direction intersecting with or perpendicular to the removing direction (forward direction) of the battery pack 10. The finger engaging portion 14 has a substantially triangular cross sectional configuration along the entire vertical length of the left side portion 10L. Similarly, the finger engaging portion 15 has a substantially triangular cross sectional configuration along the entire vertical length of the right side portion 10R. In this embodiment, the finger engaging portions 14 and 15 are formed integrally with the left and right side portions 10L and 10R, respectively. In other words, the finger engaging portions 14 and 15 are formed integrally with the battery pack body 10A. However, the finger engaging portions 14 and 15 may be formed as separate members from the battery pack body 10A and may be attached to the battery pack body 10A.

As shown in FIG. 5, the left and right finger engaging portions 14 and 15 can be used when the operator presses the operation member 12 with his or her index finger. Thus, for example, the operator may position the index finger of his or her right hand at the operation member 12, engage the thumb of the same hand with the left finger engaging portion 14 of the left side portion 10L, and engage the middle finger or the medicinal finger with the finger engaging portion 15 of the right finger engaging portion 10R, so that the operator can pinch or hold the battery pack body 10A from left and right sides. By pressing the operation member 12 with the index finger while the left and right finger engaging portions 14 and 15 being engaged by the thumb and the middle finger (or the medicinal finger) in this way, the lock member 13 is disengaged from the claw engaging portion of the tool body 2. As a result, the battery pack 10 can be removed from the battery mounting portion 3a by forwardly slidably moving the battery pack body 10A.

In the case that the operator holds the battery pack 10 with his or her left hand, the operator may position the index finger of his or her left hand at the operation member 12, engage the thumb of the same hand with the right finger engaging portion 15 of the right side portion 10R, and engage the middle finger or the medicinal finger with the finger engaging portion 14 of the left finger engaging portion 10L, so that the operator can pinch or hold the battery pack body 10A of the battery pack 10 from left and right sides.

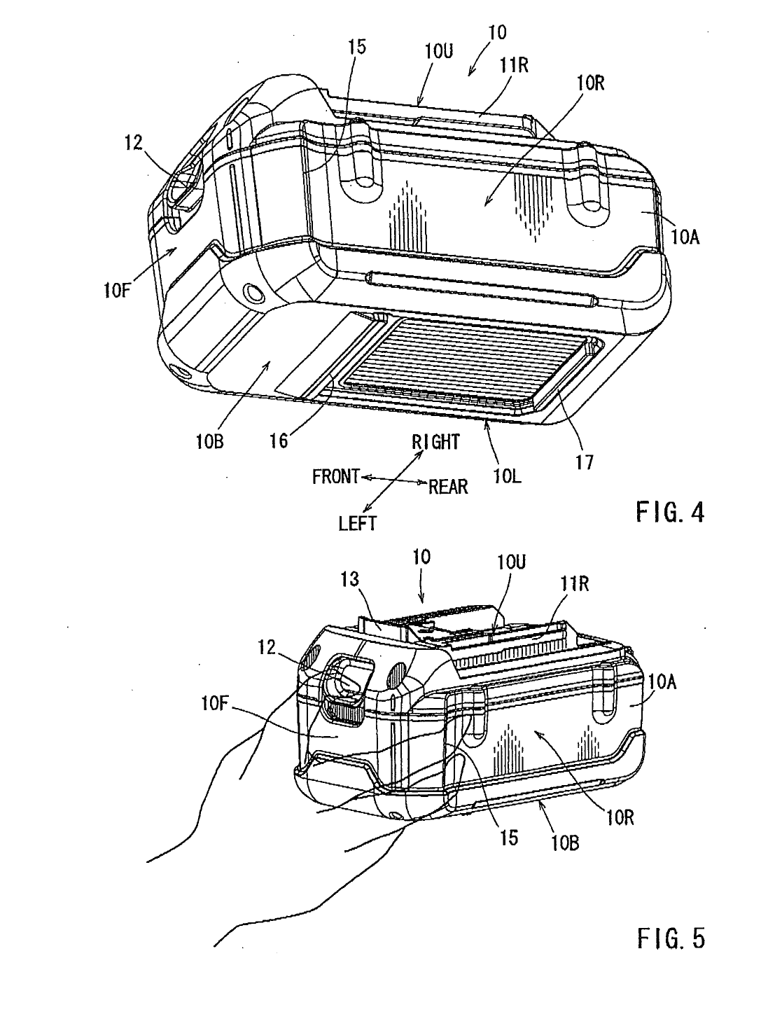

As shown in FIG. 4, the finger engaging portion 16 is disposed at a bottom side portion 10B of the battery pack body 10A. More specifically, the finger engaging portion 16 is positioned at a front part of the bottom side portion 10B. The finger engaging portion 16 is configured as a linear projection extending in a horizontal direction (left and right directions) that is a direction intersecting with or perpendicular to the removing direction (forward direction) of the battery pack 10. In this embodiment, the finger engaging portion 16 is formed integrally with the bottom side portion 10B. However, the finger engaging portion 16 may be formed as a separated member from the bottom side portion 10B and may be attached to the bottom side portion 10B.

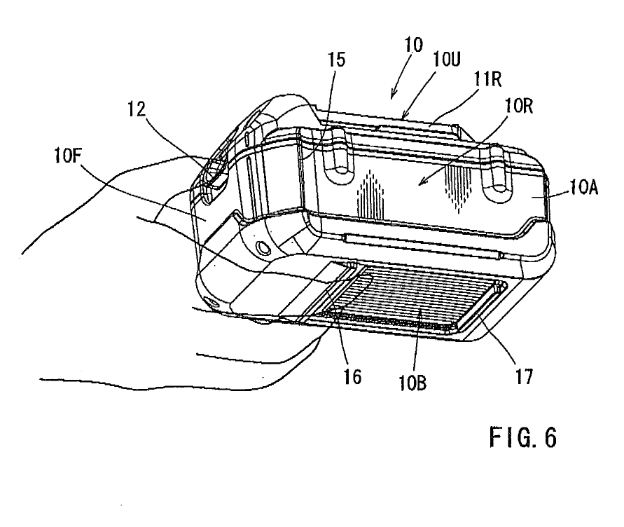

As shown in FIG. 6, the finger engaging portion 16 can be used when the operator presses down the operation member 12 with the thumb of his or her right hand. In this case, the thumb is positioned at the operation member 12 and the index finger (and/or middle finger and/or the medicinal finger) of the same hand is engaged with the finger engaging portion 16, so that the battery pack body 10A can be held from its upper and lower sides. Although not shown in the drawings, it is possible to hold the battery pack body 10A with his or her left hand in the same manner as described in connection with the right hand.

By pressing down the operation member 12 with the thumb while the index finger (and/or middle finger and/or the medicinal finger) of the same hand being engaged with the finger engaging portion 16, the lock member 13 is disengaged from the engaging portion of the tool body 2. As a result, the battery pack 10 can be removed from the battery mounting portion 3a by forwardly slidably moving the battery pack body 10A.

At the bottom side portion 10B of the battery pack body 10A, a protrusion 17 is disposed for preventing inclination of the battery pack 10. The protrusion 17 protrudes from the bottom side portion 10B by the same distance as the finger engaging portion 16 and linearly extends in the horizontal direction (right and left directions). Therefore, it is possible to prevent the battery pack 10 from inclining from the horizontal direction when the battery pack 10 is placed, for example, on a surface of a workbench. In this embodiment, the protrusion 17 is formed integrally with the bottom side portion 10B. However, the protrusion 17 may be formed as a separate member from the bottom side portion 10B and may be attached to the bottom side portion 10B.

According to the battery pack 10 constructed as described above, the finger engaging portions 14 and 15 are disposed at the left and right side portions 10L, and 10R, respectively, and the finger engaging portion 16 is disposed at the bottom side portion 10B. The finger engaging portions 14, 15 and 16 can serve as slip preventing devices when they are engaged by fingers of the operator. Therefore, the battery pack 10 can be easily mounted to and removed from the battery mounting portion 3a of the power tool 1 even in the case that the battery pack 10 is large and heavy due to its large capacity (36V). Therefore, the battery pack 10 can be easily handled.

In addition, because the protrusion 17 is disposed at the bottom side portion 10B of the battery pack body 10A to correspond to the finger engaging portion 16, the battery pack 10 can be placed horizontally on a surface of a workbench after it has been removed from the power tool 1. Further, in the mounted state of the battery pack 10 to the power tool 1 (more specifically, the battery mounting portion 3a of the handle 3 of the tool body 2), the power tool 1 can be positioned in stable on a workbench when the power tool 1 is placed on the workbench with the bottom side portion 10B of the battery pack body 10A opposed to and contacting with the surface of the workbench. This is because the battery pack 10 can be placed horizontally on the surface of the workbench.

The above embodiment can be modified in various ways. For example, although three finger engaging portions 14, 15 and 16 are provided, only the finger engaging portion 16 of the bottom side portion 10B may be provided by omitting the finger engaging portions 14 and 15 of the left and right side portions 10L and 10R. Alternatively, only the finger engaging portions 14 and 15 may be provided by omitting the finger engaging portion 16.

Furthermore, although the finger engaging portions 14 and 15 are positioned at the front parts of the left and right side portions 10L and 10R and adjacent the front corner portions of the battery pack body 10A, respectively, they may be positioned at the middle positions with respect to the left and right directions of the left and right side portions 10L and 10R, respectively. A plurality of finger engaging portions 14 may be disposed at the left side portion 10L and/or a plurality of finger engaging portions 15 may be disposed at the right side portion 10R and/or a plurality of finger engaging portions 16 may be disposed at the bottom side portion 10B.

Furthermore, although the finger engaging portions 14 and 15 are configured as linear projections extending in the vertical direction of the left and right side portions 10L and 10R, each of the finger engaging portions 14 and 15 may be configured as a recess or a plurality of parallel recesses extending in the vertical direction for engaging with fingers of the operator. Similarly, the finger engaging portion 16 may be configured as a recess or a plurality of parallel recesses extending in the horizontal direction (right and left directions) of the bottom side portion 10B.

This invention claims:

1. A battery pack for a power tool, comprising:
a battery pack body capable of being removed from the power tool in a removing direction;
wherein the battery pack body includes a finger engaging portion engageable with a finger or fingers of an operator in the removing direction of the battery pack body.

2. The battery pack as in claim 1, further comprising:
a lock device capable of releasably locking the battery pack body against the power tool; and
an operation member operable for unlocking the lock device;
wherein the battery pack body further includes;
left and right and side portions disposed on opposite sides with respect to the operation member, and
a bottom side portion extending substantially perpendicular to the left and right side portions;
wherein at least one of the left, right and bottom side portions includes the finger engaging portion.

3. The battery pack as in claim 1, wherein the finger engaging portion includes a linear projection extending in a direction intersecting with the removing direction.

4. The battery pack as in claim 1, wherein the finger engaging portion includes a linear recess extending in a direction intersecting with the removing direction.

5. The battery pack as in claim 2, wherein the finger engaging portion includes a linear projection extending in a direction intersecting with the removing direction.

6. The battery pack as in claim 2, wherein the finger engaging portion includes a linear recess extending in a direction intersecting with the removing direction.

7. The battery pack as in claim 5, wherein:
the battery pack body further includes:
a front side portion extending substantially perpendicular to the left, right and bottom side portions, and
left and right corner portions defined between the front side portion and the left and right side portions, respectively,
wherein the finger engaging portion includes a left finger engaging portion disposed at the left side portion and a right finger engaging portion disposed at the right side portion;
wherein the left finger engaging portion extends along the left corner portion; and
wherein the right finger engaging portion extends along the right corner portion.

8. The battery pack as in claim 6, wherein:
the battery pack body further includes:
a front side portion extending substantially perpendicular to the left, right and bottom side portions, and
left and right corner portions defined between the front side portion and the left and right side portions, respectively,
wherein the finger engaging portion includes a left finger engaging portion disposed at the left side portion and a right finger engaging portion disposed at the right side portion;
wherein the left finger engaging portion extends along the left corner portion; and
wherein the right finger engaging portion extends along the right corner portion.

9. The battery pack as in claim 3, wherein:
the finger engaging portion includes a bottom finger engaging portion disposed at the bottom side portion; and
the battery pack body further includes a protrusion disposed at the bottom side portion and capable of compensating inclination of the battery pack relative to a surface on which the battery pack is placed.

10. The battery pack as in claim 4, wherein:
the finger engaging portion includes a bottom finger engaging portion disposed at the bottom side portion; and
the battery pack body further includes a protrusion disposed at the bottom side portion and capable of compensating inclination of the battery pack relative to a surface on which the battery pack is placed.

11. The battery pack as in claim 7, wherein:
the finger engaging portion includes a bottom finger engaging portion disposed at the bottom side portion; and
the battery pack body further includes a protrusion disposed at the bottom side portion and capable of compensating inclination of the battery pack relative to a surface on which the battery pack is placed.

12. The battery pack as in claim 8, wherein:
the finger engaging portion includes a bottom finger engaging portion disposed at the bottom side portion; and
the battery pack body further includes a protrusion disposed at the bottom side portion and capable of compensating inclination of the battery pack relative to a surface on which the battery pack is placed.

13. The battery pack as in claim 1, wherein the battery pack has a rating voltage of 36V.

14. The battery pack as in claim 2, wherein:
the finger engaging portion includes a left finger engaging portion disposed at the left side portion and a right engaging portion disposed at the right side portion;
the left finger engaging portion and the right engaging portion are positioned relative to the operation member such that the operation member can be operated by one of fingers of one hand of an operator while the left and right engaging portions being engaged by the other two of the fingers of the same hand of the operator.

15. The battery pack as in claim 2, wherein:
the finger engaging portion includes a bottom finger engaging portion disposed at the bottom side portion; and
the bottom finger engaging portion is positioned relative to the operation member such that the operation member can be operated by one of fingers of one hand of an operator while the bottom engaging portion being engaged by the other one of the fingers of the same hand of the operator.

16. An assembly of the power tool and the battery pack defined in claim 1, wherein:
the power tool has a battery mounting portion;
the battery pack body can be releasably locked against the battery mounting portion and slidably moved along the battery mounting portion in the removing direction and a mounting direction opposite to the removing direction.
